(19) United States
(12) Patent Application Publication
(10) Pub. No.: US 2017/0098118 A1
(43) Pub. Date: Apr. 6, 2017

(54) FACE RECOGNITION USING CONCEALED MOBILE CAMERA

(71) Applicant: AGT INTERNATIONAL GMBH, Zurich (CH)

(72) Inventors: Yaacov APELBAUM, Sayville, NY (US); Shay AZULAY, Rishon LeZion (IL); Guy LORMAN, Kfar Saba (IL); Ofer SOFER, Netanya (IL); Shree GANESAN, Singapore (SG)

(21) Appl. No.: 15/312,349

(22) PCT Filed: May 18, 2015
(86) PCT No.: PCT/EP2015/060918

§ 371 Date: Nov. 18, 2016

(30) Foreign Application Priority Data
May 19, 2014 (SG) 10201402448R

(51) Int. Cl. G06K 9/00; G06K 9/20; G06K 9/22

(52) U.S. Cl. CPC G06K 9/00255; G06K 9/22; G06K 9/209

(57) ABSTRACT

A system for face recognition includes a mobile camera that is configured to be carried in a concealed manner by a user. A processor is in communication with the camera and is configured to apply face recognition to an image that is obtained from the camera. The processor is further configured to determine if a notification is to be issued and to issue a notification to a notification device.

### FIELD OF THE INVENTION

The present invention relates to face recognition using a concealed mobile camera.

### BACKGROUND OF THE INVENTION

Face recognition technology has been developed and used to identify individuals in acquired photographs and video frames. Face recognition technology is being applied, or is being developed for application, to assist law enforcement and security personnel. Such personnel may use face recognition technology, for example, to identify a previously known individual. For example, an individual may be identified whose previous activities (e.g., of a criminal nature) may indicate a need to bar entry by that individual to a particular location, or to maintain enhanced surveillance on that individual's activities. Law enforcement or security personnel may use face recognition technology to automatically detect and follow movements of an individual in order to detect any suspicious movement by that individual, e.g., possible criminal or disruptive activity.

Face recognition technology typically uses a fixed high-resolution video camera to capturing images of human faces for face recognition analysis.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 schematically illustrates a system for face recognition using a mobile camera, in accordance with an embodiment of the present invention.

FIG. 2 schematically illustrates a standalone configuration of a face recognition system, in accordance with an embodiment of the present invention.

FIG. 3 schematically illustrates a distributed configuration of a face recognition system, in accordance with an embodiment of the present invention.

FIG. 4 is a flowchart depicting a method for face recognition with a mobile camera, in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

Embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with embodiments of the present invention, a miniature mobile camera is configured to be worn or carried discretely by a user. For example, the user may be an undercover or uniformed police officer, a security guard, or another person who is required or authorized to approach people at a location. For example, the miniature mobile camera may be concealed in an eyeglass frame. As another example, the miniature mobile camera may be concealed in a tiepin, lapel pin, hat or cap, earring, necklace, or other object or article of clothing worn or carried by the user. Typically, the miniature mobile camera may be mounted in such a manner that a field of view of the camera is approximately aligned with the head of the user (e.g., in an eyeglass frame). Thus, the camera may be aimed at a face when the user looks at that face.

The eyeglass frame (or other object in which the camera is concealed) may include other components. For example, the eyeglass frame may include a microphone, speaker, light, battery, communications unit, or other components.

Acquired images may be transmitted to a processor. For example, analog video signals may be converted or encoded to a digital format by an encoder unit. The encoder unit may compress the video data to enable streaming of the data to a unit that includes a processor.

For example, the unit that includes the processor may be carried by the user (e.g., in a backpack or otherwise strapped onto or carried by the user), or by a person or object (e.g., a cart or vehicle) in the vicinity of the user. In such a case, the processor may be incorporate in a laptop or tablet computer, or in a handheld computer or smartphone. Connection between components that are near to one another may be via a wired or wireless connection.

As another example, the unit that includes the processor may be located remotely from the user. For example, data from the camera may be streamed or transmitted over a network or wireless communications link to a remote unit. For example, the remote unit may be operated or maintained by a service that provides face recognition analysis of streamed video data.

The processor may be configured to apply one or more face recognition techniques to the video data. For example, application of a face recognition technique may identify a face within an acquired image. The identified face may be compared with a database of known or previously identified faces. A match with a face in the database may indicate that the identified person should be closely monitored or observed, or removed from the premises. For example, the database of faces may include faces of individuals whose presence may be considered suspicious. Such individuals may include individuals who have previously been identified as having committed, having planned to commit, or having been suspected of committing or planning to commit an illegal, disruptive, or otherwise objectionable action in a setting that corresponds to a present setting. Individuals whose faces are included in a database may include missing persons, fugitives, a professional whose services are urgently required, or another person being sought.

When such an individual is identified, the user may be notified. For example, an alert message or tone may be transmitted to a speaker or other alert device that is incorporated into the eyeglass frame or otherwise

Face recognition using a mobile camera, in accordance with an embodiment of the present invention, may be advantageous. Since the camera may be brought close to an imaged person's face, a low resolution camera may be used. Such a camera may be less expensive than the high resolution fixed closed-circuit television cameras that are often used for face resolution. For example, the mobile camera may be similar to those that are commonly incorporated into mobile telephones and portable computers. The mobile camera may be moved by the user to point directly at a person's face. Thus, face recognition may be less complex and more accurate than face recognition from images acquired by a fixed camera in which the orientation of the person's face may not be optimal for face recognition. A mobile camera may be moved to where identification is required at a particular time and is not limited by where it is mounted.

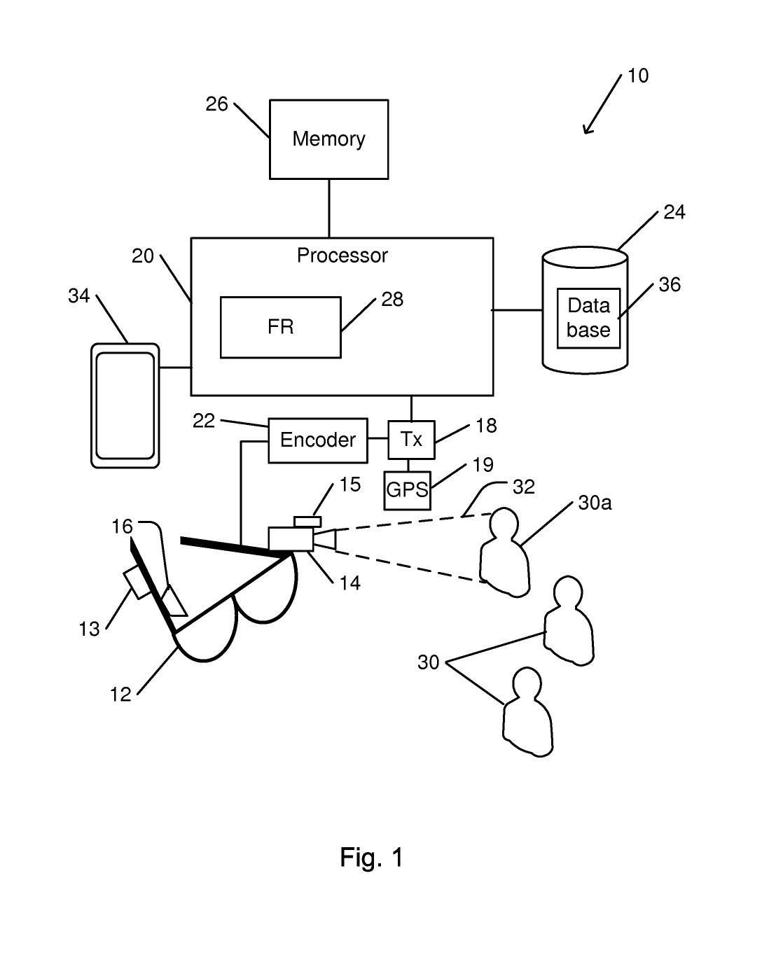

FIG. 1 schematically illustrates a system for face recognition using a mobile camera, in accordance with an embodiment of the present invention.

Face recognition system 10 may be a standalone or a distributed system.

In a standalone version of face recognition system 10, all components of face recognition system 10 may be carried or worn by a single user. For example, some components of a standalone version of face recognition system 10 may be carried in a backpack or knapsack that is carried or worn by a single user. In a standalone version of face recognition system 10, communication among components of face recognition system 10 may be wired or wireless.

In a distributed version of face recognition system 10, some components of face recognition system 10 may be carried or worn by a user, while other components are located remotely from the user. For example, eyeglass frame 12 may be worn by the user while at least some other components are located remotely from the user. For example, remote components of a distributed version of face recognition system 10 may be carried by an associate. In this case, communication among components of face recognition system 10 may be wireless. The wireless connection may be direct or via a network. Remote components of a distributed version of face recognition system 10 may be located at a server, operations center, or other remote location. In this case, communication among components of face recognition system 10 may be via a wireless network.

Face recognition system 10 includes a camera 14 concealed in eyeglass frame 12 (or another article worn or held by a user). For example, camera 14 may be concealed within a temple or endpiece of eyeglass frame 12. For example, eyeglass frame 12 may be made of a thick plastic or other material or design suitable for concealing components of face recognition system 10. Camera 14 may represent a miniaturized video camera. Eyeglass frame 12 may conceal two or more cameras, e.g., each aimed in a different direction.

Camera 14 is configured to face in a fixed direction relative to eyeglass frame 12. For example, field of view 32 of camera 14 may face forward from a front of eyeglass frame 12. Thus, a user who is wearing eyeglass frame 12 may point camera 14 toward a desired person of interest (POI) 30, such as viewed POI 30a, by facing that POI 30.

A microphone 15 may be concealed within eyeglass frame 12. Microphone 15 may be configured to acquire audio data from the surroundings of eyeglass frame 12, e.g., speech that is spoken by POI 30, such as viewed POI 30a. Microphone 15 may be directional, omni-directional, or partially directional (e.g., preferentially, but not exclusively, sensing sounds from a particular direction). Two or more microphones may be concealed by eyeglass frame 12, e.g., to sense directional information or to sense sounds that arrive from different directions relative to eyeglass frame 12. Microphone 15 may be configured to sense speech that is spoken a user who is wearing eyeglass frame 12, e.g., to enable spoken communication with another person at a remote location.

A speaker 16 may be concealed within eyeglass frame 12. For example, speaker 16 may be concealed within an earpiece of eyeglass frame 12. Speaker 16 may be configured to produce an audible sound. For example, speaker 16 may be operated to produce a warning message or signal, or audible instructions to a user who is wearing eyeglass frame 12.

Eyeglass frame 12 may include a battery 13. Battery 13 may be concealed within one or more components of eyeglass frame 12. Battery 13 may be configured to provide electrical power to one or more devices or units that are concealed within eyeglass frame 12. Two or more batteries 13 may be provided to provide power to different devices or units that are concealed within eyeglass frame 12.

Analog video or audio data that is acquired by camera 14 or microphone 15, respectively, may be transmitted to encoder 22. Encoder 22 may be configured to convert an analog video or audio signal to a digital signal. For example, the encoder 22 may convert the analog signal to a compressed digital signal that is suitable for processing by processor 20 or for wireless transmission, e.g., over a network. For example, encoder 22 may digitally encode a video signal as H.264 video format. Encoder 22 may encode an audio signal using an Advanced Audio Coding (AAC) encoding scheme. Encoder may be configured to transmit the digital signal via a wired or wireless connection to processor 20. Encoder 22 may be carried or worn by the by the user.

Digital signals encoded by encoder 22 may be transmitted to processor 20 via transmitter (Tx) 18. For example, in a standalone version of face recognition system 10, encoder 22, transmitter 18, and processor 20 may be carried together, e.g., in a single backpack or case. In this case, transmitter 18 may transmit the digital signals over a wired connection.

A Global Positioning System (GPS) receiver 19 may be associated with a user wearing eyeglass frame 12. Location and time data that is acquired by GPS receiver 19 may be transmitted by transmitter 18 to processor 20.

In a standalone version of face recognition system 10, transmitter 18 may transmit a signal to processor 20 via a wired local area network (LAN) cable.

In a distributed version of face recognition system 10, transmitter 18 may operate an antenna to transmit the signal wirelessly or over a wireless network. For example, transmitter 18 may include a subscriber identification module (SIM) or mini-SIM and a Global System for Mobile Communications (GSM) antenna to transmit digital signals over a virtual private network (VPN), e.g., as implemented by OpenVPN, using fourth generation (4G) mobile communications technology.

In some cases, transmitter 18 may transmit an analog signal to processor 20. In such a case, encoder 22 may be incorporated into processor 20, or may be in communication with processor 20. In some cases, camera 14 or microphone 15 may be configured to directly produce a digital video or audio signal, respectively. In such a case, encoder 22 may not be included in face recognition system 10, or may not operate on such a directly produced digital video or audio signal.

Processor 20 may include one or more processing units, e.g. of one or more computers. For example, processor 20 may include one or more processing units of one or more stationary or portable computers. Processor 20 may include a processing unit of a computer that is carried by the user or by an associate of the user, or may be located at a remote location such as a server, operation center, or other remote location.

Processor 20 may be configured to operate in accordance with programmed instructions stored in memory 26. Processor 20 may be capable of executing an application for face recognition. For example, processor 20 may be configured to operate in accordance with programmed instructions to execute face recognition (FR) module 28. Functionality of processor 20 may be distributed among two or more intercommunicating processing units. Different configurations of face recognition system 10 may distribute functionality of processor 20 differently among intercommunicating processing units.

Processor 20 may communicate with memory 26. Memory 26 may include one or more volatile or nonvolatile memory devices. Memory 26 may be utilized to store, for example, programmed instructions for operation of processor 20, data or parameters for use by processor 20 during operation, or results of operation of processor 20

Processor 20 may communicate with data storage device 24. Data storage device 24 may include one or more fixed or removable nonvolatile data storage devices. For example, data storage device 24 may include a nonvolatile computer readable medium for storing program instructions for operation of processor 20. The programmed instructions may take the form of face recognition module 28 for performing face recognition on a digital representation of video data. It is noted that data storage device 24 may be remote from processor 20. In such cases data storage device 24 may be a storage device of a remote server storing face recognition module 28 in the form of an installation package or packages that can be downloaded and installed for execution by processor 20. Data storage device 24 may be utilized to store data or parameters for use by processor 20 during operation, or results of operation of processor 20.

Processor 20, when executing face recognition module 28, may identify an image of a face within an acquired image. Processor 20, when executing face recognition module 28, may identify one or more identifying facial features of an identified face image. Processor 20, when executing face recognition module 28, may compare identified facial features with previously identified facial features.

Data storage device 24 may be utilized to store database 36. For example, database 36 may include previously identified facial data for comparison with a face data that is extracted by face recognition module 28 from acquired video data. For example, a data record in database 36 may include an indexed list of a set of identified facial features of a previously identified face image. Each set of facial features may be associated with indentifying information regarding a person to whom the facial features belong. For example, if the identity of the person is known, identifying information may include a name and other relevant information regarding that person (e.g., identification number, age, criminal or other record, outstanding alerts, or other relevant data). If the identity of the person is not known, identifying information may include a time and place of acquisition of an image from which the facial features were derived. The database may include identified faces that are associated with people whose presence may warrant monitoring or other action.

Data storage device 24 may be utilized to store acquired images or information (e.g., facial feature data) extracted from acquired images. Each set of stored image information may be accompanied by a time and location (e.g., as determined by GPS receiver 19).

Results of operation of face recognition module 28 may be communicated to the user. For example, if recognition of face is indicative of a requirement for action on the part of the user or by another person (e.g., law enforcement, security, or supervisory personnel), the appropriate party may be notified. For example, recognition of the face of a POI 30 or viewed POI 30a may indicate that the recognized POI should be observed, monitored, followed, approached, arrested, escorted, or otherwise related to. Processor 20 may send an audible notification (e.g., verbal message or alerting tone or sound) to the user via speaker 16 concealed in eyeglass frame 12.

Processor 20 may communicate with a user or other person via output device 34. For example, output device 34 may include a mobile telephone, smartphone, handheld computer, or other device with a capability to receive a notification from processor 20. Output device 34 may include one or more of a display screen, a speaker, a vibrator, or other output devices. A notification received by output device 34 may include visible output (e.g., including alphanumeric text, an image, graphic output, or other visible output), audible output, tactile output (e.g., a vibration), or any combination of the above.

For example, a smartphone of output device 34 may be programmed with an application that generates an appropriate notification when an appropriate in response to an event that is generated by processor 30 and communicated to output device 34. Other techniques of operation of output device 34 may be used.

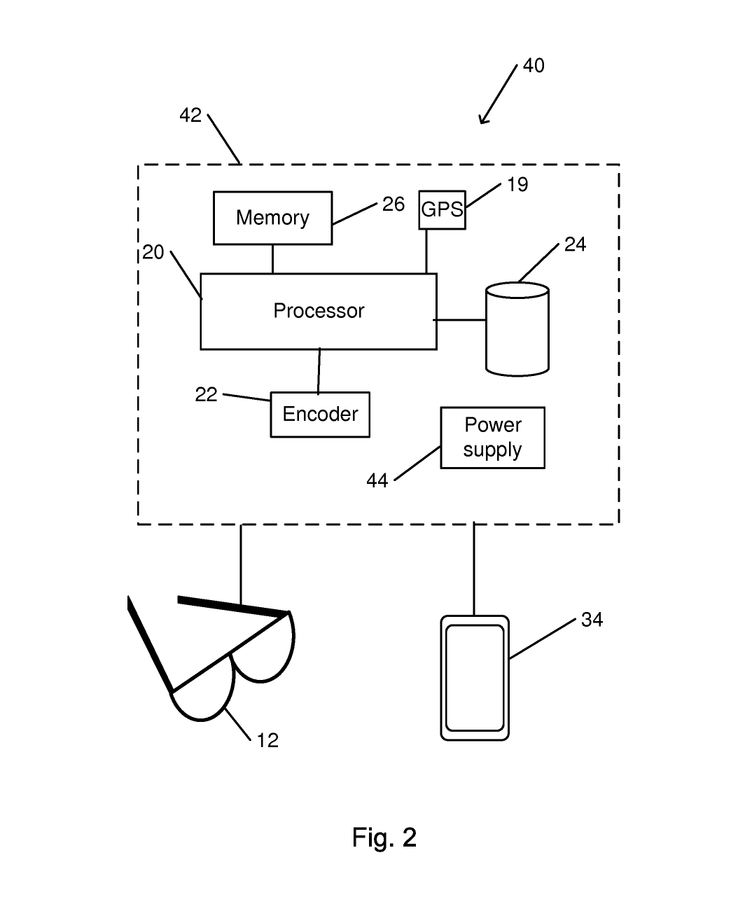

FIG. 2 schematically illustrates a standalone configuration of a face recognition system, in accordance with an embodiment of the present invention.

In standalone face recognition system 40, components are enclosed within portable module 42. For example, portable module 42 may include a backpack, knapsack, briefcase, or other container configured to hold components of standalone face recognition system 40. Portable module 42 may contain one or more of encoder 22, GPS receiver 19, processor 20, memory 26, data storage device 24, or other components. Portable module 42 may include power supply 44 for providing electrical power for one or more of the components that are included in portable module 42. For example, power supply 44 may include one or more one or more batteries, e.g., rechargeable or storage batteries.

Components in portable module 42 may communicate with components included in eyeglass frame 12. Components in portable module 42 may communicate with output device 34.

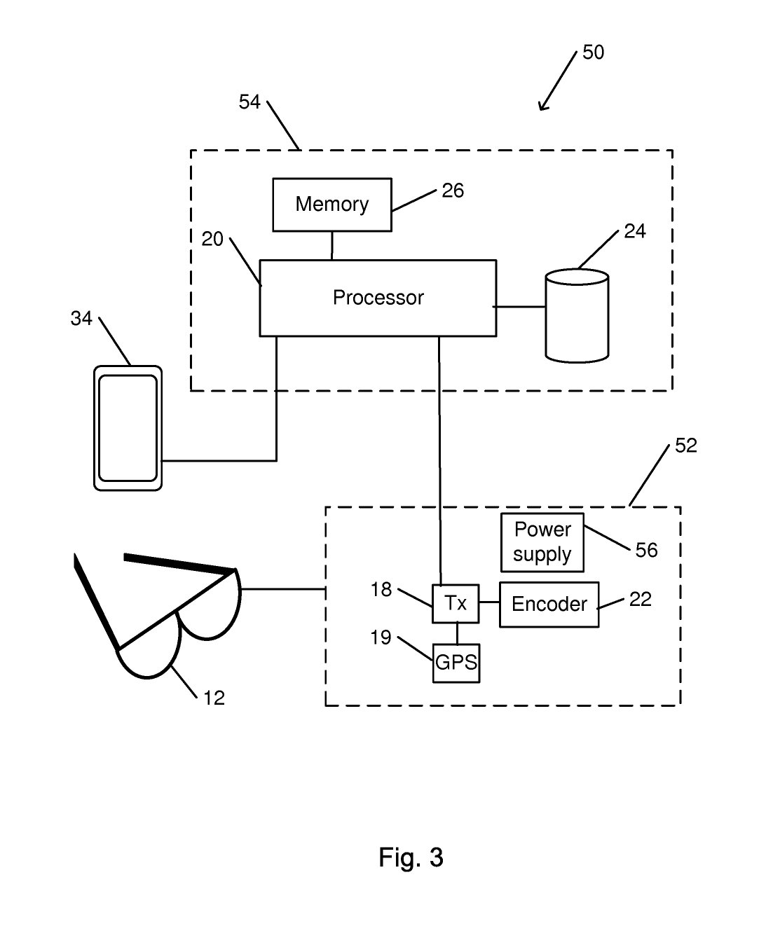

FIG. 3 schematically illustrates a distributed configuration of a face recognition system, in accordance with an embodiment of the present invention.

In distributed face recognition system 50, some components are included in a mobile unit 52. Mobile unit 52 may be worn or carried by a user who is wearing eyeglass frame 12. For example, mobile unit 52 may be strapped or otherwise attached to the user's arm, waist, or leg. Mobile unit 52 may contain one or more of encoder 22 and transmitter 18. Mobile unit 52 may (encode and) transmit video or audio data that is acquired by components of eyeglass frame 12 to components at remote station 54. Mobile unit 52 may include a GPS receiver 19.

Mobile unit 52 may include power supply 54 for providing electrical power for one or more of the components that are included in mobile unit 52. For example, power supply 54 may include one or more one or more batteries, e.g., rechargeable or storage batteries.

Components of standalone face recognition system 40 are included in remote station 54. In particular, remote station 54 may include processor 20, memory 26, data storage device 24, or other components. For example, remote station 54 may include a server or operation center of a system for face recognition.

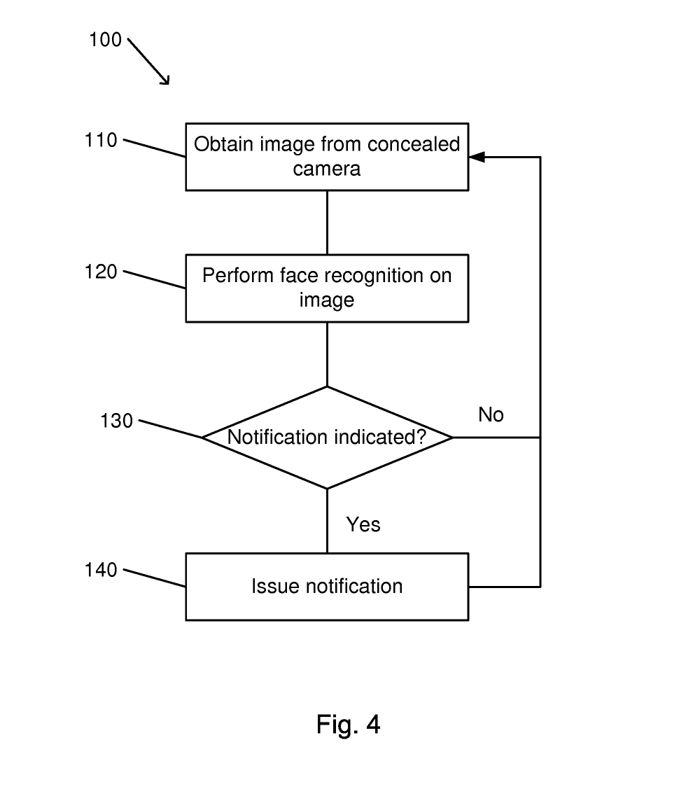

FIG. 4 is a flowchart depicting a method for face recognition with a mobile camera, in accordance with an embodiment of the present invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Mobile camera face recognition method 100 may be executed by a processor of a system for face recognition using a concealed mobile camera. For example, the processor may be carried by a user who is carrying or wearing the concealed mobile camera, or may be located remotely from the user. A remote processor may be located at a server or operations center of a system for face recognition.

Mobile camera face recognition method 100 may be executed continuously during acquisition of images by the concealed mobile camera. Alternatively or in addition, mobile camera face recognition method 100 may be executed in response to an event. For example, the user may initiate execution of mobile camera face recognition method 100 (e.g., by operation of a control) when the mobile camera is aimed at a POI. As another example, the user may be provided (e.g., may wear) a sensor that senses that a POI (or other object) is located within a field of view of the mobile camera.

An image that was acquired by a concealed mobile camera may be obtained (block 110). For example, the camera may be concealed within an eyeglass frame. The image may be a frame of streamed video.

The image may be obtained from the camera via a wired or wireless communication channel between a processor that is executing mobile camera face recognition method 100 and the camera. For example, a wireless communication channel may include a VPN or OpenVPN.

Obtaining the image may include encoding analog video data to a digital format prior to transmission. Conversion to the digital format may include compressing the image data. The digital video or image data may be streamed to a processor that is executing mobile camera face recognition method 100.

Obtaining the image may include obtaining location and time data indicating when the image was acquired, e.g., as determined by a GPS receiver.

Face recognition may be applied to the obtained image (block 120). For example, application of face recognition may include determining whether an acquired image or video frame includes an image of a face of a POI, or is consistent with a face image. One or more face images within the obtained image may be identified. One or more definable or quantifiable facial features may be identified for each identified face image.

Identified facial features may be stored for later reference (e.g., for comparison with a subsequently obtained face image, e.g., later acquired at the same or at another location by the same camera or by another camera). Identified facial features of the POI may be compared with previously identified facial features, e.g., as retrieved from a database of identified facial features.

Operations related to face recognition may indicate that a notification is to be issued (block 130). If no notification is indicated, execution of mobile camera face recognition method 100 may continue on subsequently obtained images (return to block 110).

For example, a comparison of identified facial features of a POI with previously identified facial features may result in a match. For example, a match with a database may reveal an identity of the POI. Information regarding the revealed identity may indicate that the POI should not be at the POI's present location (e.g., is expected to be elsewhere or is not authorized to be present). Information regarding the revealed identity may indicate that the POI has be known to perform illegal, disruptive, or otherwise objectionable activities or actions in a setting similar to the setting in which the POI is currently found. Information regarding the revealed identity may indicate that the POI is a person to be guarded or protected, or is being otherwise sought or paged. Comparison with recently acquired images of that POI may reveal that the recent movements of the POI indicate that the POI may be planning to act in an illegal, disruptive, or otherwise objectionable action.

A notification may be indicated, for example, when actions by the identified POI are to be closely followed or monitored, when the POI is to be removed or barred from one or more areas, when the POI is to be arrested or retained, when the POI is to be questioned or approached, when evacuation of an area is indicated or recommended, or in another circumstance when the user or another person is to be alerted, or given a command or recommendation.

When so indicated, a suitable notification is issued to a suitable notification device (block 140). For example, a notification may be issued to the user, e.g., via a notification device in the form of concealed speaker or in the form of an output device such as a smartphone. Alternatively or in addition, the notification may be issued to a device (e.g., telephone, computer terminal, workstation, alarm system, public address system, or other device) of another party, e.g., a law enforcement agency or a security dispatcher or agency, owner or manger of premises, or a another party of interest).

Mobile camera face recognition method 100 may continue to be executed, e.g., on subsequently obtained images (returning to block 110).

A face recognition system may be configured to execute mobile camera face recognition method 100 rapidly. For example, mobile camera face recognition method 100 may be executed in close to real time. Thus, for example, when so indicated, a notification may be issued to the user while the user is still aiming the concealed camera at a POI, or immediately afterward. In this manner, when a notification is received that indicates further action with respect to the identified POI, the user need not seek out the POI again after the identification and issuance of the notification.

1. A system for face recognition, the system comprising:
a mobile camera that is configured to be carried in a concealed manner by a user; and
a processor in communication with the camera and configured to:
obtain an image that is acquired by the camera;
apply face recognition to the obtained image;
determine if a notification is to be issued; and
issue a notification to a notification device.

2. The system of claim 1, wherein the camera is concealed within an eyeglass frame that is configured to be worn by the user.

3. The system of claim 1, wherein the processor is configured to be carried by the user.

4. The system of claim 3, wherein the processor is configured to be carried in a backpack.

5. The system of claim 1, wherein the processor is located remotely from the user.

6. The system of claim 5, further comprising a mobile unit that is configured to be carried by the user.

7. The system of claim 6, wherein the mobile unit comprises a transmitter to transmit an image that is acquired by the camera to the processor.

8. The system of claim 1, wherein the processor is configured to obtain the image via a wireless communication channel

9. The system of claim 8, wherein the wireless communication channel comprises a virtual private network.

10. The system of claim 1, comprising an encoder for digitally encoding an analog video signal from the camera as a digital video signal.

11. The system of claim 10, wherein the digital video signal is encoded in H.264 format.

12. The system of claim 10, wherein the encoder is further configured to encode an analog audio signal as a digital audio signal.

13. The system of claim 12, wherein the digital audio signal is encoded using an Advanced Audio Coding (AAC) encoding scheme

14. The system of claim 1, further comprising a Global Positioning System receiver to determine a location at which the obtained image was acquired.

15. The system of claim 1, wherein the notification device comprises a smartphone.

16. The system of claim 1, further comprising a concealed microphone.

17. A method for face recognition, the method comprising:
obtaining an image that is acquired by a camera that is being carried by a user in a concealed manner; and
applying face recognition to the obtained image to determine if a notification is to be issued to a notification device.

18. The method of claim 17, wherein applying the face recognition comprises determining if a face that is identified in the obtained image matches a face in a database of faces.

19. The method of claim 17 further comprising issuing the notification to the notification device.

20. A computer readable medium comprising instructions which when implemented in a processor cause the processor to implement the operations of the method of claim 17.
